(19) United States
(12) Patent Application Publication
(10) Pub. No.: US 2006/0285453 A1
(43) Pub. Date: Dec. 21, 2006

(54) METHOD AND APPARATUS FOR STABLIZING SERVO CLOSED-LOOP GAIN, PLL CLOCK AND SERVO SIGNAL THROUGH SETTING APPROPRIATE GAIN VALUE TO SERVO CLOSED-LOOP GAIN AND HOLDING PLL CLOCK AND SERVO SIGNAL WHEN POWER OF PICK-UP HEAD CHANGES

(76) Inventors: Chung-Jen Kuo, Hsin-Chu City (TW); Hsu-Feng Ho, Taipei City (TW); Chin-Yuan Hu, Chia-I City (TW)

Correspondence Address: NORTH AMERICA INTELLECTUAL PROPERTY CORPORATION, P.O. BOX 506, MERRIFIELD, VA, 22116, US

(21) Appl. No.: 11/160,347

(22) Filed: Jun. 20, 2005

(51) Int. Cl. G11B 20/10; G11B 7/00

(52) U.S. Cl. 369/47.3; 369/44.27

(57) ABSTRACT

A method for stabilizing a driving signal when an optical disc drive switches a pick-up head between a first operating mode and a second operating mode. The driving signal is utilized for controlling operation of the optical disc drive and is generated according to a read-back signal read by the pick-up head from an optical disc. The method includes: if the pick-up head is switched between the first operating mode and the second operating mode, holding the driving signal for a predetermined period of time; and when the predetermined period of time expires, stopping holding the driving signal and allowing a normal control procedure to adjust the driving signal.

### BACKGROUND

The present invention relates to a method and apparatus for stabilizing read/write operations of an optical disk drive, and more specifically, to a method and apparatus for stabilizing read/write operations through switching the servo closed-loop gains or activating a protection period when a pick-up head of an optical disk drive is switched between a read mode and a write mode.

In this modern information based society, one of the major concerns is how to manage and store tremendous amounts of information. Compared to other kinds of storage media, optical discs have a small size and a higher-density storage capacity. Due to developments in the optical disc technology, for example, CD-RW and DVD, users have the ability to repeatedly read and write data on the optical disc. Capacity and the reliability of the optical disc have also been improved. Now consumers utilize optical disc storage data very conveniently and optical disc drives have become standard equipment on their personal computers.

The reading and writing operations of an optical disc drive depend on a pick-up head, which commonly includes a laser diode or a set of laser diodes. During the read mode, the optical disc drive sets the output power of a laser diode to a desired value. Next, the optical disc drive detects reflected light from an optical disc surface to read the data stored on the optical disc. It is well known that the optical disc stores data on the surface by pits and lands, which respectively indicates “0” and “1”. This allows the optical disc drive to access data on the optical disc with a digital form by distinguishing wavelength differences between lights reflected from pits and lands.

During the write mode, the optical disc drive sets the output power of the laser diode properly according to the data waiting to be written on the optical disc. There is a large difference between the output power of the laser diode in the read mode and write mode, therefore a significant power change of the laser diode occurs when the optical disc drive undergoes a read/write transition. Unfortunately, this sudden and substantial power change is sure to influence signals within the same optical disc system, which results in unexpected signal variation. For instance, jitter of the phased-lock loop (PLL) clock, such as a wobble clock increases.

As the rotation speed of the optical disc increases, errors happen more frequently in high-speed operation. Therefore, the servo signal, and the PLL clock, for example, must be very accurate to ensure better performance. However, as mentioned above, the power change of the pick-up head induces the signal variation that results in erroneous operation or performance degradation of the optical disc drive. The optical disc drive available on the market is either ignoring this effect or utilizing a conventional closed-loop to stable these signals. Unfortunately the response time of the conventional closed-loop is usually too long. In other words, after the pick-up head is switched between the read mode and the write mode, these signals remain unstable for a short period.

Please refer to FIG. 1. FIG. 1 is a diagram illustrating a servo closed-loop gain, a PLL clock, and a servo signal under the disturbance caused by a mode transition. The pick-up head is switched from a read mode into a write mode at To, causing the power of the pick-up head to increase at the same time. As a result, the servo signal, the servo closed-loop gain, and the PLL clock are disturbed owing to the mode transition.

As to the servo closed-loop gain, it should be reduced because the laser power in the write mode is greater than that in the read mode. The servo closed-loop gain is stabilized at a lower level at T₁. As to the PLL clock, it becomes unstable due to the noise induced by the mode transition at T₀, and is stabilized by the PLL at T₂. As to the servo signal, it becomes unstable due to the noise induced by the mode transition at T₀ as well. As shown in FIG. 1, it is stabilized by a well-known servo closed-loop at T₃. The unwanted disturbance causes the optical disc drive to be unstable when reading or writing data, and may bring unexpected damage to the electrical circuit elements in the optical disc drive.

### SUMMARY

It is therefore one of the objectives of the claimed invention to provide a method and apparatus for stabling read/write operations through switching the servo closed-loop gains or activating a protection period when a pick-up head of an optical disc drive is switched between a read mode and a write mode, to solve the above-mentioned problems.

According to an embodiment of the claimed invention, a method for stabling a driving signal when an optical disc drive switches a pick-up head between a first operating mode and a second operating mode is disclosed. The driving signal is utilized for controlling operation of the optical disc drive and generated according to a read-back signal read by the pick-up head from an optical disc. The method comprises: if the pick-up head is switched between the first operating mode and the second operating mode, holding the driving signal for a predetermined period of time; and when the predetermined period of time expires, stopping holding the driving signal and allowing a normal control procedure to control the driving signal.

According to an embodiment of the claimed invention, a method for stabling a servo signal when an optical disc drive switches a pick-up head between a first operating mode and a second operating mode is disclosed. The method comprises: assigning a first gain value to the first operating mode, and assigning a second gain value to the second operating mode; and if the pick-up head is switched between the first operating mode and the second operating mode, setting a servo closed-loop gain acting upon the servo signal by the first gain value or the second gain value according to which mode is enabled.

According to an embodiment of the claimed invention, an optical disc drive is disclosed. The optical disc drive comprises: a pick-up head for accessing an optical disc; a data accessing system coupled to the pick-up head for generating a driving signal according to a read-back signal read by the pick-up head from an optical disc, the driving signal being utilized for controlling operation of the optical disc drive; and a protecting unit coupled to the data accessing system for driving the data accessing system to hold the driving signal for a predetermined period of time if the pick-up head is switched between a first operating mode and a second operating mode and for driving the data accessing system to stop holding the driving signal and allow a normal control procedure to adjust the driving signal when the predetermined period of time expires.

According to an embodiment of the claimed invention, an optical disc drive is disclosed. The optical disc drive comprises: a pick-up head for accessing an optical disc; a servo closed-loop coupled to the pick-up head for generating a servo signal according to a servo closed-loop gain, a first gain value corresponding to the first operating mode, a second gain value corresponding to the second operating mode; and a protecting unit coupled to the servo closed-loop, wherein if the pick-up head is switched between the first operating mode and the second operating mode, the protecting unit drives the servo closed-loop to set the servo closed-loop gain by the first gain value or the second gain value according to which mode is enabled.

It is an advantage of the claimed invention that the servo closed-loop gain, the PLL clock, and the servo signal are stabilized when the power of the pick-up head changes due to a mode transition. The claimed invention reduces the response time for stabilizing the servo closed-loop gain through setting an appropriate gain value to the servo closed-loop gain when the mode transition occurs. In addition, the claimed invention holds the PLL clock and the servo signal for predetermined periods, respectively, thereby causing the PLL clock and the servo signal be to free of the noise/disturbance caused by the mode transition.

These and other objectives of the claimed invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a servo closed-loop gain, a PLL clock, and a servo signal under the disturbance caused by a mode transition.

FIG. 2 is a block diagram of an optical disc drive according to an embodiment of the present invention.

FIG. 3 is a diagram illustrating a servo closed-loop gain, a PLL clock, and a servo signal stabilized by the optical disc drive shown in FIG. 2.

### DETAILED DESCRIPTION

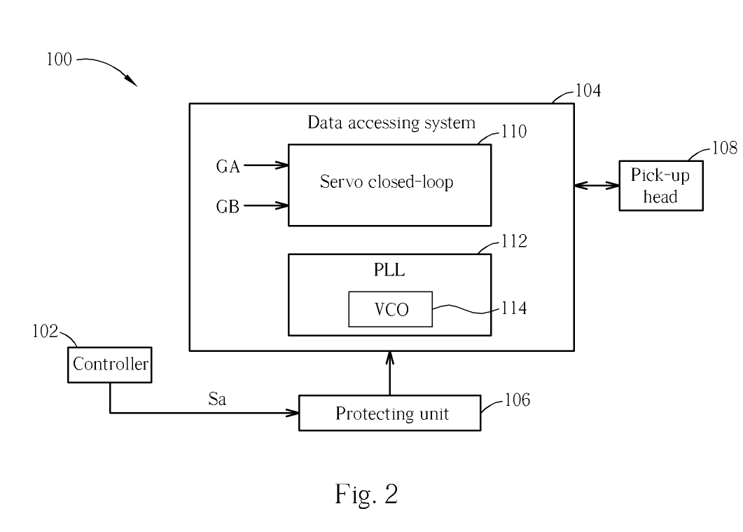

Please refer to FIG. 2, which is a block diagram of an optical disc drive 100 according to an embodiment of the present invention. In this embodiment, the optical disc drive 100 has a controller 102, a data accessing system 104, a protecting unit 106, and a pick-up head 108. The pick-up head 108 is utilized for accessing an optical disc (not shown), that is, the pick-up head 108 is capable of reading data from the optical disc under a read mode and writing data onto the optical disc under a write mode. The controller 102 is utilized for providing an alarm signal Sₐ, which has a level transition when the pick-up head 108 is switched between the read mode and the write mode. In other words, the alarm signal Sₐ toggles when the pick-up head 108 is switched from the read mode into the write mode or from the write mode into the read mode. The data accessing system 104 is a main frame of the optical disc drive 100, and drives the pick-up head 108 to perform the read/write operations. The data accessing system 104 includes a servo closed-loop 110 for running the servo control and a phase-locked loop (PLL) 112 for locking a wobble clock. It is well known that the servo closed-loop 110 generates a servo signal to control focusing/tracking of the pick-up head 108. For example, the servo closed-loop 110 generates a focus servo output (FOO) signal according to a focus error (FE) signal and generates a tracking servo output (TRO) signal according to a tracking error (TE) signal. Further, the data accessing system 104 includes a phase-locked loop (PLL) 112 for outputting a reference clock (PLL clock) according to a wobble signal read from the optical disc via the pick-up head 108. The reference clock could be utilized to generate driving clocks required by the optical disc drive 100. For example, a frequency divider is implemented to produce an EFM clock according to the reference clock. The PLL 112 has a voltage-controlled oscillator (VCO) 114 to output the above-mentioned reference clock. Since the operation and functionality of the servo closed-loop 110 and the PLL 112 is known to those skilled in the art, further description is omitted for brevity. In this embodiment, the protecting unit 106, when the pick-up head 108 is switched between the read mode and the write mode, is utilized for driving the data accessing system 104 to stabilize the PLL clock and the servo signal, and change a servo closed-loop gain of the servo closed-loop 110.

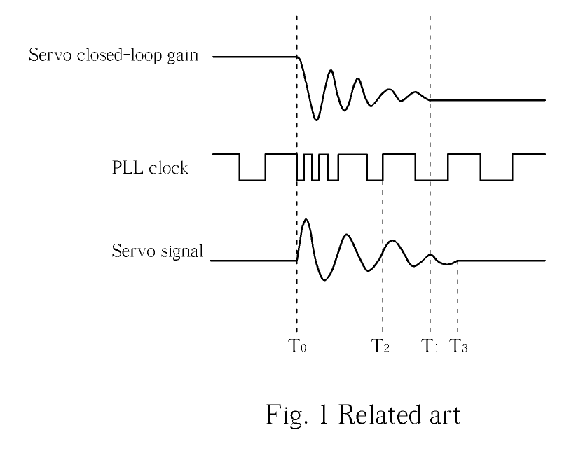

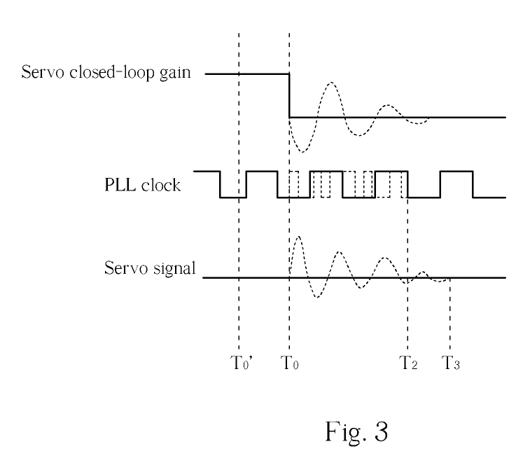

Please refer to FIG. 3 in conjunction with FIG. 1. FIG. 3 is a diagram illustrating a servo closed-loop gain, a PLL clock, and a servo signal stabilized by the optical disc drive 100 shown in FIG. 2. Assume that the pick-up head 108 is switched from a read mode into a write mode at T₀, causing the power of the pick-up head 108 to increase at the same time. As shown in FIG. 3, the dotted lines stand for the disturbance imposing on the related art optical disc drive under a normal control procedure. As mentioned before, the controller 102 is capable of outputting the alarm signal Sₐ to inform the protecting unit 106 of the timing when the pick-up head 108 is switched between the read mode and the write mode. Therefore, at T₀, the alarm signal Sₐ has a transition from a first level (e.g., logic “0”) to a second level (e.g., logic “1”). Therefore, if the protecting unit 106 detects the level transition while monitoring the alarm signal Sₐ, then the protecting unit 106 is triggered to drive the data accessing system 104 for stabilizing the PLL clock, the servo signal, and the servo closed-loop gain.

As to the servo closed-loop gain, the data accessing system 104 assigns a gain value GA for the read mode and a gain value GB for the write mode. Please note that the gain value GA is greater than gain value GB. When the protecting unit 106 is triggered by the alarm signal Sₐ, the protecting unit 106 drives the servo closed-loop 110 to set the gain value GB to the servo closed-loop gain. Because the servo closed-loop gain is determined immediately with the power change and adjusts to a suitably correct value, therefore the response time of the servo closed-loop 110 is much less than the response time of the related art closed-loop control mechanism. In other words, because the gain value GB is substantially equal to an actual servo closed-loop gain needed by the optical disc drive 100 under the write mode, the servo closed-loop gain is stabilized with minimum disturbance caused by the mode transition.

As to the PLL clock, the PLL 112 holds it for a period of time. That is, when the protecting unit 106 is triggered by the alarm signal Sₐ at T₀, the protecting unit 106 drives the PLL 112 not to adjust the frequency of the PLL clock until the period of time expires. The period defines a protection window that prevents the PLL clock from experiencing the disturbance caused by the mode transition at T₀. In this embodiment, the protecting unit 106 drives the PLL 112 to hold the control voltage inputted into the VCO 114. Therefore, the PLL clock corresponds to a stable frequency even the mode transition occurs. If the period of time corresponding to the protection window expires, a normal control procedure is allowed to adjust the PLL clock. Please note that the protection window for the PLL clock is designed to be not less than an interval between T₀ and T₂.

As to the servo signal, the protecting unit 106, similarly, drives the servo closed-loop 110 to hold the servo signal in a period of time. In other words, this period defines a protection window that prevents the servo closed-loop 110 from experiencing the disturbance caused by the mode transition at T₀. It is well known that a TRO signal is generated according to a TE signal, and an FOO signal is generated from an FE signal. Therefore, in this embodiment, the protecting unit 106 drives the servo closed-loop 110 to hold the TE signal and the FE signal, thereby causing the TRO signal and the FOO signal to remain unchanged during the defined protection window. If the period of time corresponding to the protection window expires, a normal control procedure is allowed to adjust the servo signal. For other embodiments, the protecting unit 106 can be designed to drive the servo closed-loop 110 to directly hold the TRO signal and the FOO signal. The same objective of stabilizing the servo signal is achieved. Please note that the protection window for the servo closed-loop 110 is designed to be not less than an interval between To and T₃.

As mentioned above, the timing of activating the protection window depends on the level transition of the alarm signal Sₐ. For example, the protection windows for the PLL clock and the servo signal are activated at To because the level transition of the alarm signal Sₐ is detected by the protecting unit 106 at T₀. However, the present invention is not limited to activating the protection window at the timing when the pick-up head 108 is switched between the read mode and the write mode. Because switching the pick-up head 108 between the read mode and the write mode is predictable, the controller 102 could output the alarm signal Sₐ at T₀′ prior to T₀ for informing the protecting unit 106 of the incoming mode transition. Therefore, the protection windows for the PLL clock and the servo signal are activated in advance, thereby better stabilizing the PLL clock and the servo signal. Please note that the enlarged protection window for the PLL clock is designed to be not less than an interval between T₀′ and T₂, and the enlarged protection window for the servo signal is designed to be not less than an interval between T₀′ and T₃.

As shown in FIG. 3, dotted lines illustrate the waveforms of the servo closed-loop gain, the PLL clock, and the servo signal controlled by conventional mechanism when the power of the pick-up head changes, solid lines illustrate the waveforms of the servo closed-loop gain, the PLL clock, and the servo signal controlled via the present invention mechanism. It is quite obvious that the waveforms represented by solid lines are more stable than the waveforms represented by the dotted lines, meaning better stability of the optical disc drive is obtained when the read/write mode transition occurs.

In contrast to the related art, the present invention stables a driving signal (e.g., a clock signal) via holding the driving signal or via replacing a first gain value with a second gain value when an optical disc drive switches a pick-up head between a first operating mode and a second operating mode, and the driving signal is utilized for controlling operation of the optical disc drive and is generated according to a read-back signal (e.g., a wobble signal) read by the pick-up head from an optical disc. Therefore, the present invention is capable of stabilizing the servo closed-loop gain, the PLL clock, and the servo signal when the power of the pick-up head changes due to mode transition. The present invention reduces the response time for stabilizing the servo closed-loop gain through quickly setting an appropriate gain value to the servo closed-loop gain at the time the mode transition occurs. In addition, the present invention holds the PLL clock and the servo signal for predetermined periods of time, respectively, thereby making the PLL clock and the servo signal free of the noise/disturbance caused by the mode transition.

Those skilled in the art will readily observe that numerous modifications and alterations of the device and method may be made while retaining the teachings of the present invention. Accordingly, the above disclosure should be construed as limited only by the metes and bounds of the appended claims.

What is claimed is:

1. A method for stabling a driving signal when an optical disc drive switches a pick-up head between a first operating mode and a second operating mode, the driving signal being utilized for controlling operation of the optical disc drive and being generated according to a read-back signal read by the pick-up head from an optical disc, the method comprising:
if the pick-up head is switched between the first operating mode and the second operating mode, holding the driving signal for a predetermined period of time; and
when the predetermined period of time expires, stopping holding the driving signal and allowing a normal control procedure to adjust the driving signal.

2. The method of claim 1, further comprising:
providing an alarm signal which has a level transition when the pick-up head is switched between the first operating mode and the second operating mode; and
monitoring the alarm signal for detecting the level transition;
wherein holding the driving signal for the predetermined period of time is started when the level transition is detected.

3. The method of claim 1, wherein the first operating mode is a read mode and the second operating mode is a write mode.

4. The method of claim 1, wherein the driving signal is a servo signal.

5. The method of claim 4, wherein the servo signal is a tracking servo output (TRO) signal.

6. The method of claim 4, wherein the servo signal is a focus servo output (FOO) signal.

7. The method of claim 4, wherein the servo signal comprises a tracking servo output (TRO) signal and the focus servo output (FOO) signal.

8. The method of claim 4, wherein the servo signal is a tracking servo output (TRO) signal generated from a tracking error (TE) signal and holding the driving signal being performed by holding the TE signal.

9. The method of claim 4, wherein the servo signal is a focus servo output (FOO) signal generated from a focus error (FE) signal and holding the driving signal being performed by holding the FE signal.

10. The method of claim 4, wherein the servo signal comprises a tracking servo output (TRO) signal and a focus servo output (FOO) signal, the TRO signal is generated from a tracking error (TE) signal, the FOO signal is generated from a focus error (FE) signal, and holding the driving signal is performed by holding both of the TE signal and the FE signal.

11. The method of claim 1, wherein the read-back signal is a wobble signal, and the driving signal is a clock signal.

12. The method of claim 11, wherein the clock signal is generated by a phase locked loop (PLL) according to the wobble signal, the PLL has a voltage controlled oscillator (VCO) for outputting the clock signal, and holding the driving signal is performed by holding a control voltage inputted into the VCO.

13. A method for stabling a servo signal when an optical disc drive switches a pick-up head between a first operating mode and a second operating mode, the method comprising:
assigning a first gain value to the first operating mode, and assigning a second gain value to the second operating mode; and
if the pick-up head is switched between the first operating mode and the second operating mode, setting a servo closed-loop gain acting upon the servo signal by the first gain value or the second gain value according to which mode is enabled.

14. The method of claim 13 further comprising:
providing an alarm signal which has a level transition when the pick-up head is switched between the first operating mode and the second operating mode; and
monitoring the alarm signal for detecting the level transition;
wherein setting the servo closed-loop gain acting upon the servo signal by the first gain value or the second gain value is started when the level transition is detected.

15. The method of claim 13, wherein the first operating mode is a read mode and the second operating mode is a write mode.

16. An optical disc drive comprising:
a pick-up head for accessing an optical disc;
a data accessing system coupled to the pick-up head for generating a driving signal according to a read-back signal read by the pick-up head from an optical disc, the driving signal being utilized for controlling operation of the optical disc drive; and
a protecting unit coupled to the data accessing system for driving the data accessing system to hold the driving signal for a predetermined period of time if the pick-up head is switched between a first operating mode and a second operating mode and for driving the data accessing system to stop holding the driving signal and allow a normal control procedure to adjust the driving signal when the predetermined period of time expires.

17. The optical disc drive of claim 16 further comprises:
a controller coupled to the pick-up head and the protecting unit for providing an alarm signal which has a level transition when the pick-up head is switched between the first operating mode and the second operating mode;
wherein the protecting unit monitors the alarm signal for detecting the level transition and drives the data accessing system to hold the driving signal when the level transition is detected.

18. The optical disc drive of claim 16, wherein the first operating mode is a read mode and the second operating mode is a write mode.

19. The optical disc drive of claim 16, wherein the driving signal is a servo signal.

20. The optical disc drive of claim 19, wherein the servo signal is a tracking servo output (TRO) signal.

21. The optical disc drive of claim 19, wherein the servo signal is a focus servo output (FOO) signal.

22. The optical disc drive of claim 19, wherein the servo signal comprises a tracking servo output (TRO) signal and the focus servo output (FOO) signal.

23. The optical disc drive of claim 19, wherein the servo signal is a tracking servo output (TRO) signal generated from a tracking error (TE) signal and holding the driving signal being performed by holding the TE signal.

24. The optical disc drive of claim 19, wherein the servo signal is a focus servo output (FOO) signal generated from a focus error (FE) signal and holding the driving signal being performed by holding the FE signal.

25. The optical disc drive of claim 19, wherein the servo signal comprises a tracking servo output (TRO) signal and a focus servo output (FOO) signal, the TRO signal is generated from a tracking error (TE) signal, the FOO signal is generated from a focus error (FE) signal, and holding the driving signal is performed by holding both the TE signal and the FE signal.

26. The optical disc drive of claim 16, wherein the read-back signal is a wobble signal, and the driving signal is a clock signal.

27. The optical disc drive of claim 26, wherein the data accessing system comprises a phase locked loop (PLL) to generate the clock signal according to the wobble signal, the PLL has a voltage controlled oscillator (VCO) for outputting the clock signal, and holding the driving signal is performed by holding a control voltage inputted into the VCO.

28. An optical disc drive comprising:
a pick-up head for accessing an optical disc;
a servo closed-loop coupled to the pick-up head for generating a servo signal according to a servo closed-loop gain, a first gain value corresponding to the first operating mode, a second gain value corresponding to the second operating mode; and
a protecting unit coupled to the servo closed-loop, wherein if the pick-up head is switched between the first operating mode and the second operating mode, the protecting unit drives the servo closed-loop to set the servo closed-loop gain by the first gain value or the second gain value according to which mode is enabled.

29. The optical disc drive of claim 28 further comprises:
a controller coupled to the pick-up head and the protecting unit for providing an alarm signal which has a level transition when the pick-up head is switched between the first operating mode and the second operating mode;
wherein the protecting unit further monitors the alarm signal for detecting the level transition, and drives the servo closed-loop to set the servo closed-loop gain by the first gain value or the second gain value when the level transition is detected.

30. The optical disc drive of claim 28, wherein the first operating mode is a read mode and the second operating mode is a write mode.
